(19) United States
(12) Patent Application Publication
(10) Pub. No.: US 2005/0223851 A1
(43) Pub. Date: Oct. 13, 2005

(54) Can opening tool

(76) Inventor: Bill J. Hays, Bandon, OR (US)

Correspondence Address: Robert E. Strauss, 74527 Moss Rose Drive, Palm Desert, CA, 92260, US

(21) Appl. No.: 10/820,206

(22) Filed: Apr. 8, 2004

(51) Int. Cl. B67B 7/00

(52) U.S. Cl. 81/3.2

(57) ABSTRACT

A tool for opening pull-tab type of metal containers is disclosed. The typical pull-tab type of metal container is cylindrical and has a circular, recessed top with a weakened separation line about its periphery. A metal pull tab which has an integral loop is riveted to the top and the user bends the loop up sufficiently to grasp and pull the loop, separating the top from the container. The opening tool has a shaft terminating at its working end with an elongated blade which has an open, longitudinal slot forming two longitudinal segments. One segment extends beyond the open slot and terminates in a flat blade which is preferably tapered. The tool is used by inserting the tapered blade tip beneath the loop of the pull tab to raise the loop sufficiently to permit the open-ended slot of the tool blade to be slipped over the loop. Once the loop is received within the slot, the user simply rotates the tool shaft about its axis to peel the top from the container.

### FIELD OF INVENTION

This invention relates to a can opening tool and, in particular, to a tool useful for opening the pull-tab opening cans and a method of use of the tool to open pull-tab opening cans.

### BACKGROUND OF THE INVENTION

A recent improvement in sealed food containers is the pull-tab metal can in which the can top has a peripheral failure line surrounding the top and a tab on its upper surface which can be grasped by the consumer to pull the top from the can. Although this improvement is intended to provide greater ease of access to the contents of the container by avoiding the necessity for a can cutter opener, it actually increases the difficulty of opening for many persons, particularly persons suffering from arthritis and other incapacitating diseases. Such persons experience difficulties in accessing the pull tab and lack the finger dexterity and strength to pull the tab sufficiently to release the can top.

### SUMMARY OF THE INVENTION

This invention comprises a tool for opening pull-tab type of metal containers. The typical pull-tab type of metal container is cylindrical and has a circular, recessed top with a weakened separation line about its periphery. A metal pull tab which has an integral loop is riveted to the top and the user bends the loop up sufficiently to grasp and pull the loop, separating the top from the container. The tool of this invention has a shaft terminating at one end with a handle for grasping and terminating at its opposite, working end with an elongated blade. The blade has an open, longitudinal slot forming two longitudinal segments. One segment extends beyond the open slot and terminates in a flat blade which is preferably tapered. The tool is used by inserting the tapered blade tip beneath the loop of the pull tab to raise the loop, and the open-ended slot of the tool blade is slipped over the loop. Once the loop is received within the slot, the user simply rotates the tool shaft about its axis. Since this motion only requires hand grasping and wrist motion, it can usually be performed by most persons, including those who suffer from arthritis or similar disabilities, without undue effort.

### BRIEF DESCRIPTION OF THE DRAWINGS

The invention will be described by reference to the drawings of which:

FIG. 1 is an isometric view of the tool of this invention;

FIG. 2 illustrates use of the tool to lift the pull tab of a container;

FIG. 3 illustrates placement of the tool about the pull tab preparatory to opening of the container;

FIG. 4 illustrates opening of the container by rotation of the tool about its axis;

FIG. 5 illustrates a power-assisted tool;

FIG. 6 illustrates a tool having a blade that terminates in a flatted tip; and

FIG. 7 illustrates an alternative tool for use with a conventional tool driver.

### DESCRIPTION OF THE PREFERRED EMBODIMENTS

Referring to FIG. 1, the tool 10 of the invention has a shaft 12 which is preferably cylindrical, although shafts of other cross sections such as polygon, e.g., square, rectangular, hexagonal, etc., are also useful. At one end, the shaft 12 terminates with a torque transmitting means, which in a simple embodiment comprises the end of shaft 12 being fixedly received in a handle 14 of suitable contour and size to permit facile grasping in one's hand. The working end 16 of the shaft 12 terminates in a blade 18 which has a longitudinal slot 20 that divides the end 16 into two segments 22 and 24 of unequal length. The slot 20 is open at the end of the shaft 12 and the longer segment 24 extends beyond the slot opening 26 of the blade 18. The longer segment 24 terminates in a tip 28 of reduced thickness. The shaft 12 can be machined from rod stock by various techniques, such as high pressure water cutting, or can be formed by sintered metal technology from suitable metals such as steel, stainless steel, aluminum alloys such as 75T6 and 6061 alloys. Alternatively, the shaft can be fabricated by injection molding of suitably strong or high grade plastics.

In its preferred embodiment, the shaft has a diameter from 0.25 to about 0.40 inch and the slot 20 has a thickness from 0.085 to about 0.125 inch and a length from 0.75 to about 1.0 inch, both slot dimensions being sufficient to loosely receive the loop of a conventional pull tab.

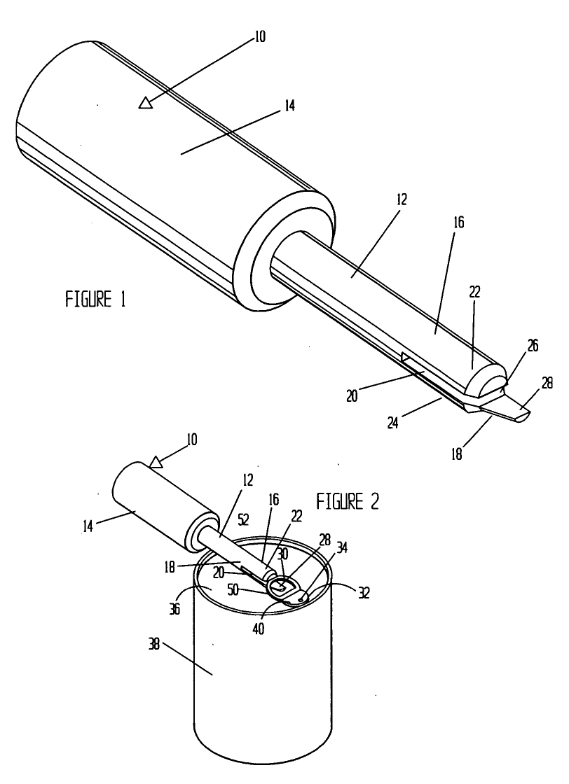

FIG. 2 illustrates the use of the tool 10 to lift the pull loop 30 of a conventional pull tab 32 that is attached, usually with a rivet 34, to the top 36 of a pull tab container 38. The pull tab 32 has a base 40 with an integral loop 30 having a bight 50 that closely lies against the surface of the can top 36. Conventional with such containers is a peripheral failure line 52 that extends around the container top 36. The end of the longer segment 24 of the blade terminates in a tapered tip 28 which is slid beneath the bight 50 of the pull tab loop 30 and the tool 10 is rotating upwardly, lifting the loop 30 from the surface of the can top 36. Although the tool 10 is shown as oriented normal to the base 40 of the loop 30, it can be oriented at any acute angle to the base 40.

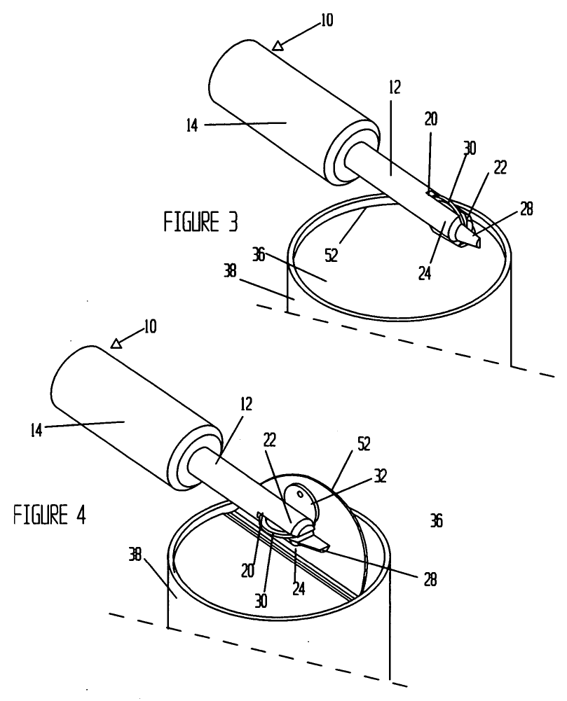

Once the loop 30 is tilted upwardly from the surface of the can top 36, the slot 20 of the tool blade 18 can be readily slid over the loop 30, receiving the loop, moving into the orientation shown in FIG. 3. After the loop is received in the slot, with the shaft 12 of the tool 10 substantially parallel to the base of the pull tab, the user simply rotates the shaft 12 of the tool. In the illustrated embodiment the shaft 12 is fixedly secured to the handle 14 and the user simply rotates the tool handle 14 with wrist motion. This motion ruptures the failure line 52, lifting the top 36, as shown in FIG. 4. The continued rotation of the tool handle will cause the top to roll or wrap about the shaft 12, severing the top 36 entirely from the container 38. The wrapped can top 36 is readily separated from the tool 10, since the slot 20 is open-ended, and the tool is easily slipped from the can top, permitting disposal of the top, requiring only that the user tilt the tool 10 into a vertical position, and the wrapped top 36 will fall from the tool shaft 12.

FIG. 5 illustrates an alternate construction as tool 55 in which the handle 56 is hollow to form a housing 58 that contains an electric motor with appropriate reduction gearing. Preferably the housing 58 has air circulation ports 60. The shaft 12 is rotatably supported in the housing 58 and secured in a driven relationship to the electric motor. This assembly can use conventional portable electric hand tool mechanism such as a speed reducing gear box which is connected to the output shaft of the motor, with the gear box output shaft fixedly secured to shaft 12. In its most preferred embodiment, the electric motor is a low voltage D.C. motor and the handle 56 includes a power cartridge 62 that contains a rechargeable battery. The power cartridge 62 can be permanently secured to the motor housing 58, or can be removable for recharging.

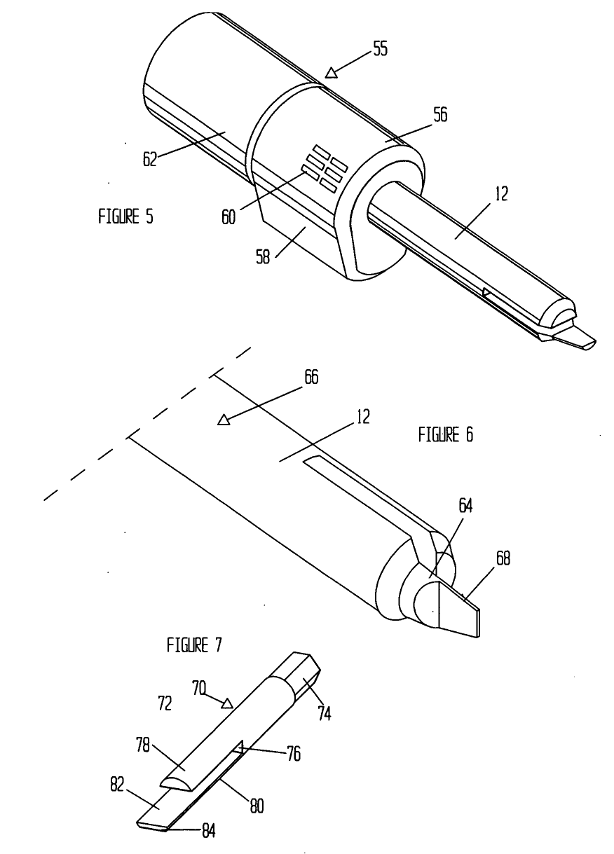

FIG. 6 illustrates another construction as tool 66, having a shaft 12, similar to that previously described. In this embodiment, the tip 64 of the tool shaft 12 is shaped with a flatted tip blade 68 to provide ease of insertion of the tip blade 68 beneath the bight 50 of the pull tab loop 30, as shown in FIG. 1.

FIG. 7 illustrates a tool 70 which is suitable for use with a conventional driver that has a tool receptacle with a hexagonal cross section. The shaft 72 of the tool has a hexagonally flatted end 74 to be received in the receptacle of the driver. The opposite end of the shaft 72 has a longitudinal end slot 76 which divides the shaft into two segments 78 and 80. Segment 80 extends beyond the end of segment 78 with a end portion 82 that has a tip 84 which is preferably flatted to reduce its thickness, similarly to tip 68 shown in FIG. 6. If desired, the tip 84 can also to tapered similarly to the tapering of tip 68. This embodiment can be used with a conventional screw driver having a tool receptacle to receive the flatted end 74 of tool 70. The screw driver can be a handle for manual use, or can be a conventional power driven driver, preferably with a rechargeable battery.

The invention has been described with reference to the illustrated and presently preferred embodiment. It is not intended that the invention be unduly limited by this disclosure of the preferred embodiment. Instead, it is intended that the invention be defined by the means, and their obvious equivalents, set forth in the following claims.

1. A tool for opening pull-tab closed containers characterized by a sealed container top having a failure line about the periphery of said top and having a tab permanently secured to said top adjacent a peripheral edge thereof, which tool comprises:
a. a shaft with one end terminating in a torque transmitting means and, at its opposite end, having a working end;
b. said working end having a slot open to the end of said shaft and extending longitudinally along said shaft, dividing said working end of said tool into two longitudinal segments;
c. one of said longitudinal segments extending beyond the terminus of the other segment; and terminating in a blade with a blade tip having thickness less than the thickness of said one longitudinal segment.

2. The tool of claim 1 wherein said torque transmitting means comprises a handle which fixedly receives said shaft

3. The tool of claim 2 wherein said shaft is round.

4. The tool of claim 2 wherein said slot has a length from 0.75 to about 1.0 inch and equal to or slightly greater than the width of said tab.

5. The tool of claim 3 wherein said slot has a width from 0.08 to about 0.13 inch and slightly greater than the thickness of said tab, whereby said tab can be loosely received in said slot.

6. The tool of claim 1 wherein said blade tip is flatted.

7. The tool of claim 1 wherein said one end of said shaft is rotatably received in said handle and including an electric motor received within said handle and a gear box with an input shaft in driven connection to said motor and an output shaft fixedly secured to said one end of said shaft.

8. The tool of claim 6 including a rechargeable battery in electrical connection to said electrical motor.

9. The tool of claim 1 wherein said torque transmitting means comprises a plurality of longitudinal flats about said one end.

10. The tool of claim 1 wherein said one end has a hexagonal cross section.

11. The method of opening a pull-tab closed container characterized by a sealed container top having a peripheral failure line and a tab permanently secured to said top adjacent a peripheral edge thereof, which comprises:
a. grasping the handle of a tool having a distally extending shaft having a working end with an open, longitudinal slot with distal longitudinal segments; and
b. sliding the working end of said tool over said tab, to receive said tab into said slot;
c. rotating said tool about its longitudinal axis to sever said top from said can; and
d. retracting said tool from said top by withdrawing said tool in a longitudinal direction substantially along its longitudinal axis

12. The method of claim 8 wherein said tab has a loop portion closely adjacent to the top surface of said container top, including the step of inserting the tip of said shaft beneath said loop portion and prying said loop portion to erect said loop portion above said container top, preparatory to step b.
